(19) United States
(12) Patent Application Publication
(10) Pub. No.: US 2011/0099347 A1
(43) Pub. Date: Apr. 28, 2011

(54) MANAGING ALLOCATION AND DEALLOCATION OF STORAGE FOR DATA OBJECTS

(76) Inventors: James M. Plasek, Shoreview, MN (US); Kelsey L. Bruso, Minneapolis, MN (US)

(21) Appl. No.: 12/605,458

(22) Filed: Oct. 26, 2009

(51) Int. Cl. G06F 12/14; G06F 12/00; G06F 12/02

(52) U.S. Cl. 711/163; 711/170; 711/E12.001; 711/E12.094

(57) ABSTRACT

Various approaches for managing storage for data objects. In one approach, data describing a plurality of allocation control areas are stored. Each allocation control area references a respective set of free pages that are available for allocation for storing data objects. In response to a request to delete a data object, a non-blocking exclusive lock is sought on an initial one of the allocation control areas. If the lock is granted, each page having data of the data object is returned to the respective set of free pages of the initial one of the allocation control areas. If the lock is denied, another one of the allocation control areas to which a non-blocking exclusive lock can be granted is determined, and each page is returned to the respective set of free pages of the other one of the allocation control areas.

### FIELD OF THE INVENTION

The present invention generally relates to managing allocation and de-allocation of storage for data objects.

### BACKGROUND

Accesses to binary large objects (BLOBs) in many applications typically follow a write-once-read-many (WORM) pattern. This means that the BLOB is written once to storage and thereafter read many times. Some systems for managing the storage allocated to BLOBs have been constructed under this assumption. However, not all applications in which BLOBs are accessed follow the WORM access pattern, which may negatively impact system performance.

An example application involving BLOBs and not following the WORM access pattern involves message passing in which the message includes a BLOB. In such an application, the message is transient and is not expected to be read many times. Where the message is transient, the message would be written once, read once or maybe a few times, and then deleted and the storage returned to the system and made available for storing a subsequent message.

The message passing function may be part of a larger transaction processing application in which multiple transactions are processed concurrently. In such an application there would be multiple transactions concurrently involved in obtaining storage for new messages and deleting messages and returning the storage to the system.

Since a WORM access pattern does not entail frequent deletions of a data object, there is less contention involved in the allocating and de-allocating of storage than there is when the access pattern follows that of a transient message as described above. Where there are more conflicts involved in the allocating and de-allocating of storage, there is reduction in system performance since one transaction may be forced to wait to allocate/de-allocate storage until another transaction has completed its allocation/de-allocation of storage.

A method and system that address these and other related issues are therefore desirable.

### SUMMARY

The various embodiments of the invention provide methods and systems for managing storage for data objects. In one embodiment, a method comprises storing data describing a plurality of allocation control areas. Each allocation control area references a respective set of free pages of a storage arrangement that are available for allocation for storing data objects. In response to a request to delete a data object, the method requests a non-blocking exclusive lock on an initial one of the allocation control areas. In response to the lock being granted, each page having data of the data object is returned to the respective set of free pages of the initial one of the allocation control areas. In response to the lock being denied on the initial one of the allocation control areas, the method determines another one of the allocation control areas to which a non-blocking exclusive lock can be granted, and returns each page having data of the data object to the respective set of free pages of the other one of the allocation control areas.

According to another method for managing storage of data objects, data are stored describing a plurality of allocation control areas. Each allocation control area has an associated respective set of free pages that are available for allocation for storing data objects. Before any pages have been allocated from the allocation control areas for storing data objects, the allocation control area under which each respective set of free pages is maintained is a home allocation control area of the respective set of free pages. In response to a request to store a data object, the method requests a non-blocking exclusive lock on a first one of the allocation control areas. If the non-blocking exclusive lock is granted on the first one of the allocation control areas, the method removes one or more free pages from the respective set of free pages of the first one of the allocation control areas, stores data of the data object in the one or more pages, and stores in one of the one or more pages an identifier of the home allocation control area of the one or more pages. In response to a request to delete the data object, the method requests a non-blocking exclusive lock on a second one of the allocation control areas. If the non-blocking exclusive lock is being granted for the second one of the allocation control areas, the method returns each page having data of the data object to the second one of the allocation control areas. If the non-blocking exclusive lock is denied on the second one of the allocation control areas, the method determines a third one of the allocation control areas to which a non-blocking exclusive lock can be granted, and returns each page having data of the data object to the third one of the allocation control areas.

A system is provided for managing storage for data objects. A processor arrangement is coupled to a memory. The memory is configured with instructions that are executable by the processor arrangement for controlling deallocation of memory from data objects. The instructions, when executed by the processor arrangement, cause the processor executing the instructions, to write to the memory, data describing a plurality of allocation control areas. Each allocation control area referencing a respective set of free pages of a storage arrangement is available for allocation for storing data objects. In response to a request to deallocate memory from a data object, the processor requests a non-blocking exclusive lock on an initial one of the allocation control areas. If the non-blocking exclusive lock is granted, the processor adds each page having data of the data object to the respective set of free pages of the initial one of the allocation control areas. If the non-blocking exclusive lock is denied on the initial one of the allocation control areas, the processor determines another one of the allocation control areas to which a non-blocking exclusive lock can be granted, and adds each page having data of the data object to the respective set of free pages of the another one of the allocation control areas.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 illustrates an example database table in which the database includes non-BLOB and BLOB data;

FIG. 2 illustrates one embodiment of a database table for managing non-binary-large-object (BLOB) and BLOB data in accordance with one embodiment of the invention;

FIG. 3A illustrates one prior art embodiment of a storage layout for a database table such as shown in FIG. 2 having non-BLOB and BLOB data;

FIG. 3B illustrates a second prior art embodiment of a storage layout for a database table having non-BLOB and BLOB data;

FIG. 4 illustrates an embodiment of a storage layout for a database table;

FIG. 5 is a logical block diagram of a file 500 in accordance with an embodiment of the invention;

FIG. 6 is a block diagram showing an example allocation control area and the subset of free pages managed with the allocation control area;

FIG. 7 is a flowchart of an example process for allocating free pages of a file to a data object, for purposes of inserting the object in a database, for example;

FIG. 8 is a flowchart of an example process for returning pages to an allocation control area after deleting an object from a database, for example;

FIG. 9A shows an allocation control area and examples of the associated free pages before deleting a data object, FIG. 9B shows the pages of the data object to be deleted; and FIG. 9C shows the allocation control area and the associated free pages after the data object has been deleted; and

FIG. 10 is a block diagram of an example computing arrangement which can be configured to implement the processes described herein.

### DETAILED DESCRIPTION

The embodiments of the present invention provide approaches for managing the allocation and de-allocation of storage for data objects. In one embodiment, a plurality of allocation control areas are maintained. Each allocation control area references a respective set of free pages of a storage arrangement, where the free pages in the set are available for allocation for storing data objects. When a data object is deleted, the storage allocated to that data object is returned to one of the allocation control areas. In order to reduce contention for access to the allocation control areas, when a data object is to be deleted a non-blocking exclusive lock is requested on an initial one of the allocation control areas. Since the data structure of the allocation control area will be modified in returning the storage allocated to the data object, an exclusive lock is required in order to avoid corrupting the data structure. The request is non-blocking in that if the lock cannot be granted, control is returned to the transaction seeking the lock along with an indicator that the lock was denied. Note that processing of a blocking exclusive lock request is different from the non-blocking request in that if the lock cannot be granted, the requesting transaction is queued until the lock can be granted.

In response to the non-blocking exclusive lock being granted, each page having data of the data object is returned to the respective set of free pages of the initial one of the allocation control areas. In response to the non-blocking exclusive lock being denied on the initial one of the allocation control areas, the embodiments of the invention determine another one of the allocation control areas to which a non-blocking exclusive lock can be granted. Each page having data of the data object is then returned to the respective set of free pages of that one of the allocation control areas for which the non-blocking exclusive lock was granted.

The embodiments of the invention are particularly suitable for managing storage for data objects that are of a large data type (LDT). The embodiments of the invention may be employed in managing data that is associated with a record of a database table, but which is not stored within the database table itself since the data is of a LDT that is too large to be readily stored within the actual database table. LDTs include binary large objects (BLOBs), character large objects (CLOBs), national character large objects (NCLOBs), any other type of objects or Large Objects (LOBs), computer aided design (CAD) files, extended markup language (XML) documents, objects, and any other data type that is associated with data of a size that is not readily stored within the database table itself, and is therefore stored within another location that is referenced by the database table.

Although some of the following discussion focuses on the use of BLOB data, this is merely for illustrative purposes. It will be understood that this discussion applies equally to any other type of LDT data.

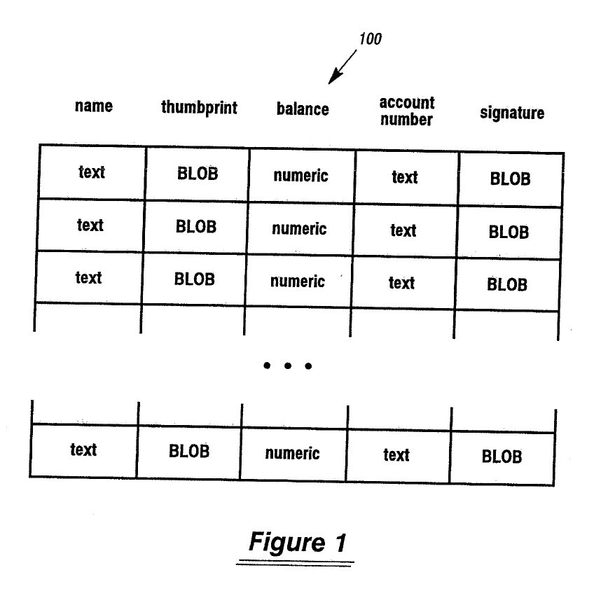

FIG. 1 illustrates a database table 100 for an example transaction in which the database includes non-Binary-Large-OBject (BLOB) data and BLOB data. The table is not intended to depict the actual data structures involved in managing the data. Rather, FIG. 1 is intended to illustrate an example of a table that is associated with both non-BLOB and BLOB data. A set of related BLOB data will be referred to as a “BLOB.” A “BLOB” generally represents a complex data object that has an internal structure that is not necessarily important or visible to the database engine. Thus, a BLOB is stored as a very long string of binary digits that are handled as an object. The BLOB may be a very long string of discrete binary data, such as an image in raw format or a segment of a binary encoded signal. Alternatively, a BLOB could be an image in an encoded format including multiple groups of discrete data, such as video.

The text and numeric fields in the example table are fixed length fields such as those conventionally included in relational databases. For example, name may be a fixed length character string, and balance may be a real number represented with a fixed number of bits. BLOBs, on the other hand, may be fixed or variable length data objects, depending on the application. Each BLOB can be retained in contiguous storage so that BLOBs can be read or written with a single I/O operation.

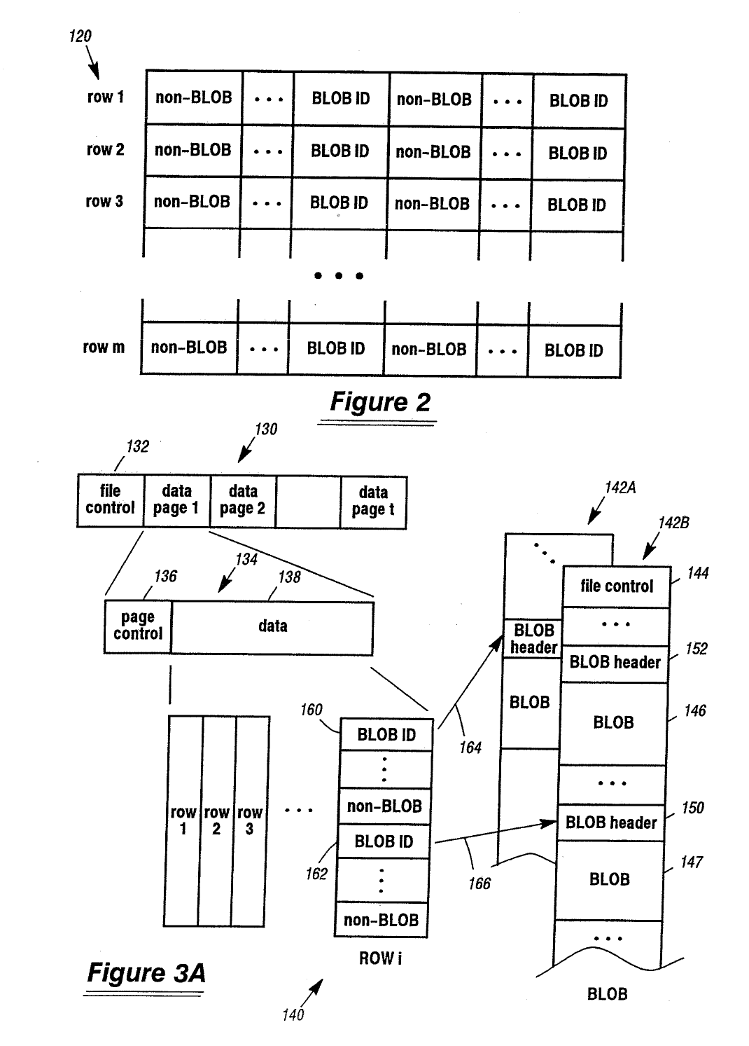

FIG. 2 illustrates one embodiment of a database table for managing non-BLOB and BLOB data. Each of rows 1-m in the exemplary database table 120 includes non-BLOB data, for example, text and/or numeric data, and BLOB identifiers (ID) which reference BLOBs.

In one embodiment, a BLOB identifier includes an address code, a length code, and a cyclic redundancy check (CRC) code. The address is the storage address at which the BLOB begins and can be used to construct an I/O request for transfer of the BLOB from storage to memory.

The length code indicates the number of words comprising the BLOB and is used to indicate in the I/O request the number of words to read from storage. Since each BLOB is stored contiguously, a single I/O request can be used to retrieve a BLOB. Contiguous storage refers to consecutive physical storage addresses.

The CRC code is used to determine whether a BLOB has been corrupted. The CRC code is generated when a BLOB is inserted in the database. When the BLOB is retrieved from the database, the stored CRC can be compared to the CRC code which is generated when the BLOB is read.

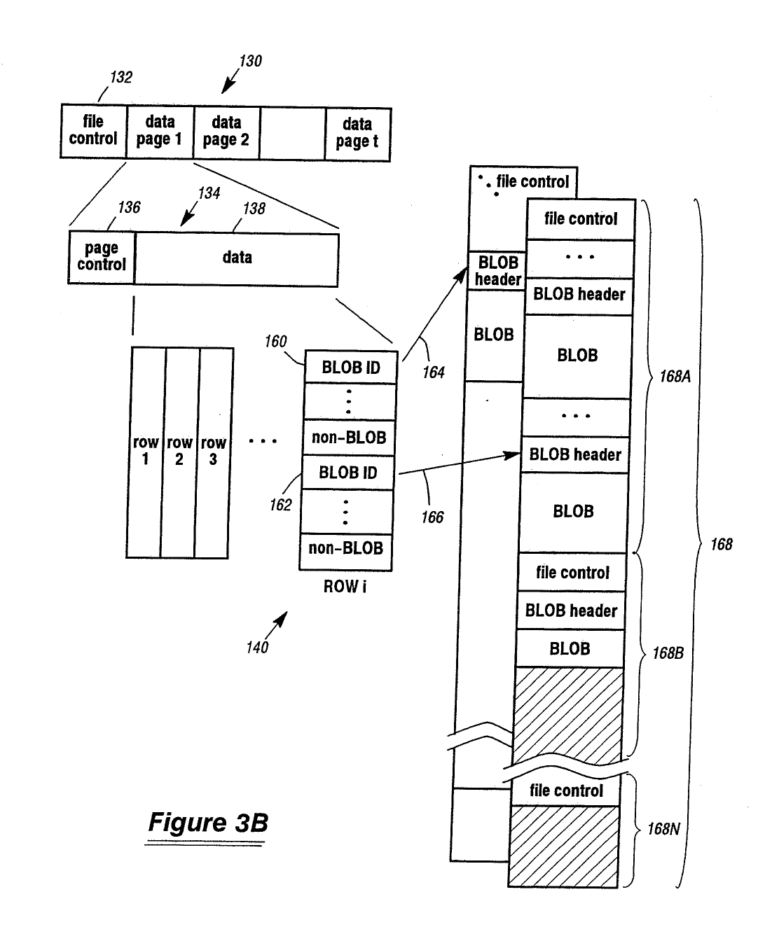

FIG. 3A illustrates one prior storage layout for a database table such as shown in FIG. 2 having non-BLOB and BLOB data. FIG. 3A provides a logical view of file 130 for storage of a database table. Thus, the actual storage occupied by file 130 may not be contiguous. Alternatively, file 130 may be arranged in contiguous storage in other embodiments. File 130 includes file control block 132, along with a plurality of data pages 1-t. File control block 132 is a block of file information that is conventionally associated with a data file and whose contents are dependent upon the database management system. The data pages 1-t store application-specific information. In this context, “application” refers to the database management system that is responsible for file 130.

The content of each of data pages 1-t is illustrated by page 134. In an application such as a database management system, each page includes page control block 136 and data block 138. The content of page control block 136 is specific to the application controlling the page. For example, a database management system includes a page number code which tells the number of the page, a page size code which tells the size of the page, number of words on the page available for records, and number of words on the page already used for records for allocating space from the page to data records.

Each data block 138 stores one or more rows 1-i of data, depending upon the number of elements within a row and the lengths of the elements. Some tables may be defined to include columns that contain non-BLOB data, and other columns associated with BLOB data, as shown in FIG. 2. As previously discussed, the non-BLOB data is stored directly in the table. For those columns associated with BLOB data, each column stores a BLOB ID identifying the storage address for the respective BLOB data. For example, row i, 140, of FIG. 3A, contains a column 160 that stores a BLOB ID. This BLOB ID identifies a storage location within BLOB file 142A that stores BLOB data and an associated BLOB header describing the data, as indicated by arrow 164. The BLOB header is discussed further below.

As is depicted by FIG. 3A, in one embodiment, each column that is associated with BLOB data is associated with a respective BLOB file. For instance, assume that each of columns 1-i have two columns associated with BLOB data. These columns 160 and 162 are shown for row i. Each of these columns is respectively associated with a different BLOB file for storing BLOB data. In FIG. 3A, column 160 is associated with BLOB file 142A, and column 162 is associated with BLOB file 142B. As a result, each BLOB ID stored within column 160 of any row of the table will identify a BLOB header and corresponding BLOB data stored within file 142A. Likewise, each BLOB ID stored in column 162 of any row will point to a BLOB header and BLOB data retained within file 142B. This is indicated by arrows 164 and 166, respectively.

BLOB files 142A and 142B are each a data file that occupies contiguous storage. BLOB file 142B is shown to include file control block 144 and a plurality of BLOBs, 146, 147, with each BLOB having an associated BLOB header 150, 152 that precedes the BLOB. BLOB file 142A is similarly configured.

A BLOB header of one embodiment includes the following data items that are used for managing the associated BLOB:
Number of pages is the number of consecutive data pages comprising storage of the BLOB (including the header page).
Validation string is data that is used to detect page corruption and to detect where a BLOB image starts. In one embodiment, the data is the character string “IaMaBlOb”.
Creation timestamp is the time at which the BLOB was written to the storage area and has a precision level of nanoseconds. In one embodiment, the creation timestamp is used to validate the ownership of a BLOB image by its ‘owning’ row. The creation time of the row must match the creation time of the corresponding BLOB.
Previous BLOB header references the BLOB header that precedes the BLOB header in the BLOB file.
Next BLOB header references the BLOB header that follows the BLOB header in the BLOB file.

The configuration shown in FIG. 3A is associated with some performance limitations which involve archive and recovery operations, as follows. Periodically, an archive operation must be performed during which a BLOB file such as file 142A is copied to non-volatile storage. The copy of the BLOB file that is maintained in non-volatile storage may then be used to recover BLOB file 142A if a failure occurs.

While BLOB file 142A is being copied to non-volatile storage, no additional BLOBs may be stored within file 142A, and existing BLOBs stored within this file may not be deleted or modified. BLOB data within file 142A may be accessed solely for read-only purposes. Thus, during the archive operation, BLOB file 142A is said to be “down for updates.”

After an archive operation is completed, many changes may be made to BLOB file 142A before the next archive operation is initiated. Each change to BLOB file 142A may be recorded within non-volatile storage using an audit trail process. This process makes copies of individual records as the records are changed. This is faster than creating a new archived copy each time any record is updated.

Next, assume that a failure occurs such that BLOB file 142A must be restored. During the recovery process, the last archived copy of BLOB file 142A is retrieved from non-volatile storage. The individual record modifications that were recorded following creation of the archive copy are then applied to re-create the latest state of this file.

Applying the audit trail changes to the archive copy is very time-consuming. During this time, the BLOB file is unavailable for both update and read-access requests. Therefore, it is important to complete recovery as quickly as possible. One way to do this is to create archive copies more frequently so that fewer audit trail changes must be used to obtain the latest state of the database.

As may be appreciated from the foregoing discussion, on one hand, it is advantageous to create archive copies of BLOB file 142A frequently because it minimizes the time the file is unavailable during recovery. On the other hand, each time the archive copy is created, the BLOB file 142A is unavailable for updates, thereby slowing throughput during normal operations.

FIG. 3B illustrates a prior art configuration that is similar to that shown in FIG. 3A. The elements similar to those shown in FIG. 3A are labeled with like numeric designators. The configuration of FIG. 3B differs from that shown in FIG. 3A in that a list of a predetermined number of multiple files is provided for each column of the table that stores BLOB data. For example, file list 168 is provided to store data for column 160. This file list includes files 168A-168N. Any number of files may be included within this list. A similar file list is shown for column 162.

A file list is used to store BLOB data for a column when a single file of the largest size allowable by the memory management system cannot accommodate all BLOB data for a given column. A file list may also be used in those situations wherein the database administrator determines that a set of smaller files should be allocated to store the BLOB data so that backup and recovery operations complete more quickly for that BLOB data.

A file list is a group of files that the database management system views as a single block of storage space that is to be allocated in a contiguous manner. For example, when a first request is received to store BLOB data for column 160, space is allocated at the start of the first file 168A in file list 168. When a next request is received to store BLOB data for column 160, BLOB data is stored immediately following the first BLOB data, and so on. When a request is received to store BLOB data that is too large for the space remaining in the first file in the file list, space allocation begins at the start of second file 168B in the list. The next request stores BLOB data at the first available location within that second file, and so on. All requests to store BLOB data are now directed to the second file 168B until this file is too full to accommodate a request. Processing continues in this manner, managing the file list as a single block of memory that must be allocated contiguously. All unused storage space remains at the end of the list, as shown by the hashed areas in files 168B-168N.

File lists are used for several reasons. First, BLOB data may be very large. To use memory efficiently to store this large amount of data, it is desirable to allocate memory contiguously so that unused “pockets” of memory are not created. Moreover, allocating memory contiguously simplifies the memory management process. Finally, when this type of memory management system is utilized, very little, if any, memory compaction is required to consolidate the areas of unused memory, since that consolidation is performed at allocation time.

The approach of FIG. 3B suffers from the same performance limitations as are described in reference to FIG. 3A, above. BLOB data is always being added to a predetermined file in the file list. This predetermined file is generally the file that stored BLOB data for the last request that involved record creation. If that predetermined file does not contain enough storage to accommodate the request, the next file in the file list is utilized. When an archive operation is occurring for that predetermined file, no record creation can be performed since the entire BLOB storage space is considered “down for updates.” Thus, processing for all requests that involve record creation must be postponed until the archive operation is completed.

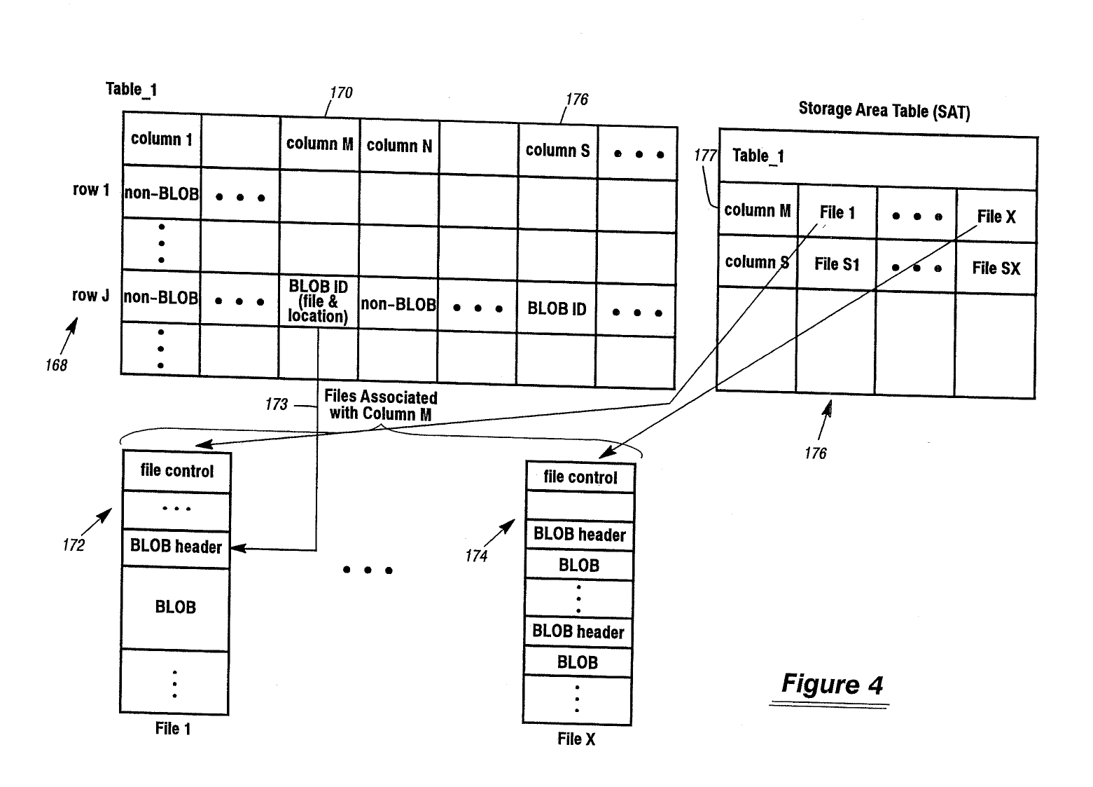

FIG. 4 partially illustrates an embodiment of the invention that includes a database table “Table_{—}1” having non-BLOB and BLOB data. In this embodiment, each column associated with BLOB data is associated with a file set containing any number of files available to store the BLOB data for this column. For instance, FIG. 4 shows an example database table that includes column M, 170, which is associated with BLOB data. A set of files 172-174 is provided for storing this BLOB data. In one embodiment, up to 511 files may be included in this set of files. In an alternative embodiment, this file set may include more or fewer files.

The database management system that manages allocation of BLOB data views each of the files 172-174 as an independently selectable file, rather than as a single block of storage space that, for allocation purposes, is contiguous, as was the case in the prior art. This provides significant advantages over prior art systems, as will be discussed below.

At the time the database table of FIG. 4 is created, a corresponding Storage Area Table (SAT) 176 is also created. This data structure includes an entry for each of the columns of Table_{—}1 that are associated with BLOB data. In the illustrated example, an entry is created for columns M and S. Each of these entries includes a description of the corresponding file set. This description comprises a list of the file names, the location of each file, as well as the size of each of these files. In some embodiments, the description may further include the amount of storage space available in each of the files. For instance, in FIG. 4, the entry 177 for column M identifies, and points to, each of files 172-174 for that column. A similar entry is created for a different file set (not shown in FIG. 4) that is created for column S of Table_{—}1. Each of the files 172-174 of FIG. 4 includes a file control block, and is capable of storing multiple BLOBs. Each BLOB has a corresponding BLOB header. As will be described further below, each file control block further describes multiple allocation control areas for managing those pages in the file that are available for storing new data objects.

FIG. 4 illustrates that the BLOB ID in row J, column M, identifies both a file 172 and a location within that file at which the corresponding BLOB data resides. This is indicated by arrow 173. As previously stated, this BLOB data may be stored within any of files 172-174, since all of these files are individually selectable to store data for column M, and there is no restriction on the way the data must be stored within these files.

The files in a file set may be stored in a variety of ways. All of the files may reside on the same data processing system, or some of the files may reside on a system different from that storing others of the files. Some of the files may be stored on one type of non-volatile media, while others may be stored on a different type of media.

The size of the files in a file set may be determined in one of several ways. According to one embodiment, a file is allocated N blocks of space, wherein N is a positive integer. Each block is sized to accommodate a BLOB having the maximum allowable BLOB size. Each time a BLOB is stored to a file of a file set, the BLOB is allocated to a respective block such that the data for consecutive BLOBs within a file may not be stored contiguously. A file is considered full when all blocks of the file have been allocated.

In another embodiment, the blocks of a file are sized such that one or more blocks are employed to store the data for a single BLOB. In this embodiment, the smallest number of blocks that can accommodate a given BLOB are allocated to store that BLOB. In yet another embodiment, a file need not be divided into blocks such that the BLOB data may be stored contiguously. Other alternatives are, of course, available.

In a manner similar to that shown for column M, a different set of files is provided to store the BLOB data for column S, 176. As is the case with the file set for column 170, the storage for this additional file set is viewable by the database management system as being independently selectable such that memory can be allocated without regard to any particular ordering of the files. Because BLOB data can be stored on any of the files at any time without regard to a file ordering convention, the short-comings of the prior art system are overcome. For instance, when one of files 172-174 is down for updates because an archive copy is being created in non-volatile storage, the remaining files in the file set are never-the-less available for database requests. This can be illustrated by example. Assume the file set 172-174 includes 500 files, and only file 174 is down for updates because an archive copy is being created. Further assume that the BLOB data for column M is to be updated within row j. This update operation will occur to file 172, and thus can be processed without delay, as can any other update request that occurs to the other 499 files that are not down for updates.

It may be noted that by decreasing the size of each of the files in the file set, the time required to complete an archive operation for a file can be minimized. Thus, the number of files in a file set may be increased while the size of each file may be decreased, thereby minimizing the time any file is unavailable for updates. As noted above, however, even though a given file is down for updates, record creation may continue since BLOB data for that record can be inserted in any file in the file set.

An observation similar to the foregoing may be made regarding recovery operations. Assuming a failure may be isolated to a single one of files 172-174, recovery of this file can occur without disrupting requests to read, or write data, within the remaining files of the file set. Recovering any one of the files can occur much more quickly than would otherwise occur if a single file or file list were used to store all BLOB data for a given column of the database table.

The number of files that are allocated to store the BLOB data for a given column of the database may be selected by a systems administrator or another appropriate professional based on a number of factors. These factors may include the size of the typical BLOB data that will be associated with one record for the column. If this BLOB data is very large, a larger number of files may be needed. Other factors may include the maximum time a file may be unavailable, either during an archive or a recovery operation. As this time is reduced, the size of a given file must also be reduced. This, in turn, requires that more files are provided in the file set.

Programmable business rules may be utilized by the system to determine the number of files to include in a given file set. These programmable business rules may be integrated into the database management system, and may take into account factors that are similar to those discussed above. In this manner, the operation of each system may be entirely automated, and may be tailored to the individual needs of each client.

It may be noted that the current system may result in the allocation of storage for BLOB data in a manner that results in more memory fragmentation. This disadvantage is now considered to be outweighed by the significant performance benefits that are achieved, particularly in light of today's ever-decreasing size and cost of storage space.

As noted above, the exemplary system and method described in reference to FIG. 4 discusses the storage of BLOB data within files of a file set. However, file sets that are created and managed as described above may be employed in this manner to store any LDT data.

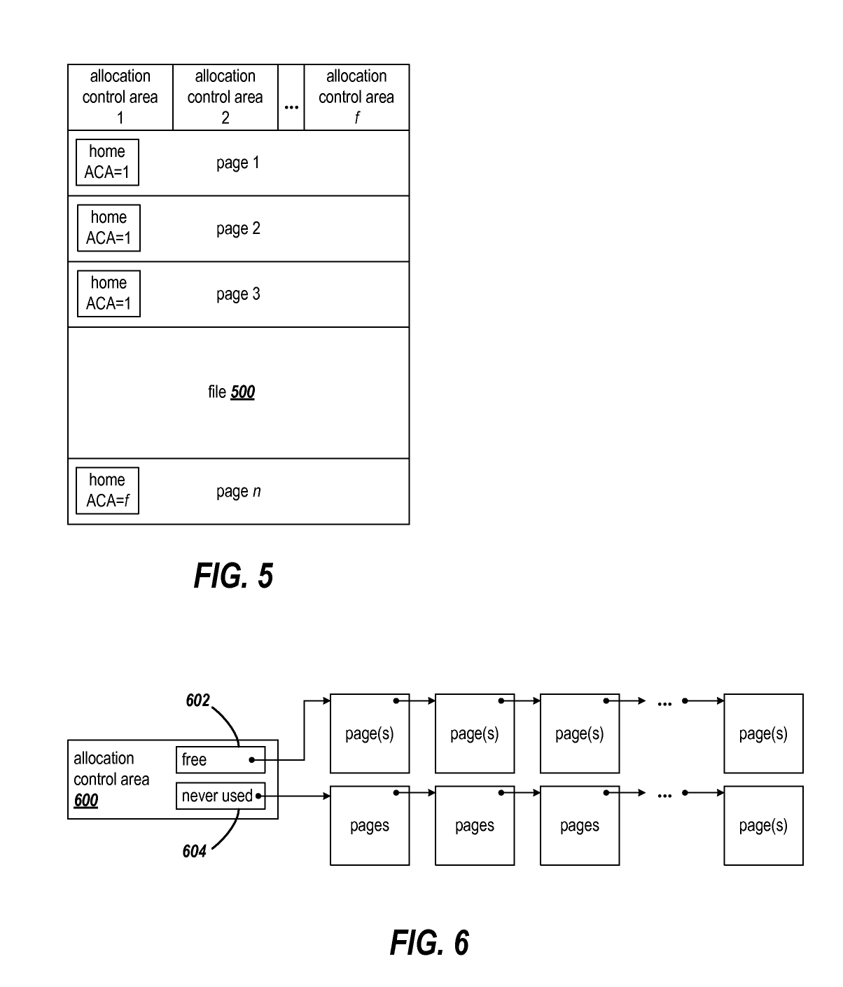

FIG. 5 is a logical block diagram of a file 500 in accordance with an embodiment of the invention. The depiction of file 500 is an alternative view of the files 1-X as shown in FIG. 4. Whereas FIG. 4 shows the BLOB information in a file, FIG. 5 shows the control structures used in managing the allocation of the physical pages of the file.

In order to further alleviate contention between transactions inserting and deleting objects, a plurality of allocation control areas 1-f are maintained. In one embodiment, the information that describes each allocation control area is maintained in the file control area (e.g., FIG. 3A, 144) of each file. Each allocation control area is used in managing a subset of free pages of the file. When an object is to be inserted into the database, storage for the object is allocated from the subset of free pages managed under one of the allocation control areas. Similarly, when an object is to be deleted from the database, the pages storing data of the object are returned to the subset of free pages managed by one of the allocation control areas.

The multiple allocation control areas are generally used as follows when inserting or deleting an object. For both types of transactions, exclusive access is required to the one of the allocation control areas from which the pages are to be removed or to which the pages are to be returned. In order to reduce contention and thereby increase throughput, rather than requesting a blocking exclusive lock on the access control area, a non-blocking exclusive lock is requested. As explained previously, for a non-blocking lock request if the lock cannot be granted, control is returned to the transaction seeking the lock along with an indicator that the lock was denied. For a blocking exclusive lock request if the lock cannot be granted, the requesting transaction is queued until the lock can be granted. If the lock is denied, a non-blocking exclusive lock request is submitted for another of the allocation control areas.

Table 1 below explains system behavior when a second transaction makes non-blocking and blocking exclusive lock requests for an object having a current lock status as a result of actions associated with a first transaction. The entries in the table where the second transaction is seeking a read lock are unrelated to requesting a non-blocking exclusive lock for inserting or deleting an object, but are shown to illustrate the overall locking behavior.

TABLE 1

| | Second | | | |
|---|---|---|---|---|
| | transaction | | Second | Second |
| | requests non- | | transaction | transaction |
| Lock status of | blocking | Second transaction | requests non- | requests |
| allocation control | exclusive | requests blocking | blocking read | blocking read |
| area: | update | exclusive update | lock | lock |
| No lock is held | Return: lock | Return: lock | Return: lock | Return: lock |
| | granted | granted | granted | granted |
| READ lock held by | Return: | Queue second | Return: lock | Return: lock |
| first transaction | lock denied | transaction | granted | granted |
| (blocking or non- | | (blocked) until the | | |
| blocking) | | first either commits | | |
| | | or rolls back | | |
| UPDATE lock held | Return: | Queue second | Return: | Queue second |
| by first transaction | lock denied | transaction | lock denied | transaction |
| (blocking or non- | | (blocked) until the | | (blocked) until |
| blocking) | | first either commits | | the first either |
| | | or rolls back | | commits or rolls |
| | | | | back |

In another embodiment of the invention, each of the allocation control areas is a home allocation control area for one of the subsets of free pages. Before any pages have been allocated from the allocation control areas for storing data objects, the allocation control area that references each respective set of free pages is a home allocation control area of the respective subset of free pages. In an attempt to promote pages of available storage being physically contiguous, which may be beneficial for storing BLOBs, when an object is deleted an attempt is first made to return the pages to the home allocation control area. If the home area is already locked, the pages may be returned to another one of the allocation control areas.

In one embodiment, the deletion of an object always tries to return the pages to the home allocation control area first. Thus, if the pages were previously returned to another one of the allocation control areas, then allocated from that other allocation control area, and are now being returned again, the pages may be migrated back to the home allocation control area. To support the home allocation control areas, in one embodiment an identifier of the home allocation control area is stored in the header of each page. For example, in FIG. 5, pages 1, 2, and 3 are in home allocation control area 1, and page n is in home allocation control area f.

FIG. 6 is a block diagram showing an example allocation control area and the subset of free pages managed with the allocation control area. In one embodiment, the free pages are maintained in two linked lists or chains. Both chains contain free pages. However, one of the chains contains free pages that have never been allocated for storage of a data object. This special class of free pages is referred to as never-used free pages. The free chain contains pages that are available for allocation and that have been previously allocated and then returned to the allocation control area. The free pages under allocation control area 600 include the pages linked in free chain 602 and the pages linked in the never-used chain 604.

Each entry on the free chain 602 includes a single page or multiple physically contiguous pages that can be accessed with a single input/output request. Each entry references the address of the next entry in the chain. In one embodiment, the never used chain 604 is similarly structured. However, since the pages in the never-used chain have never been allocated, each item in the chain would include multiple physically contiguous pages. In another embodiment, the never-used pages may be a single block of contiguous pages rather than a chain.

When inserting a data object and seeking pages to allocate, the system looks first to see if there are sufficient pages on the free chain to satisfy the request. If so, the pages are allocated from the free chain. If the free chain does not contain a sufficient number of free pages, the system uses pages from the never-used chain. The never-used chain is considered second in order to maintain some number of physically contiguous pages for use when the free pages are exhausted.

When an object is to be deleted, the pages of the object are returned to the free chain. If any of the pages of the deleted object are physically contiguous with pages in the free chain, those pages are combined into a single allocable data area in the free chain.

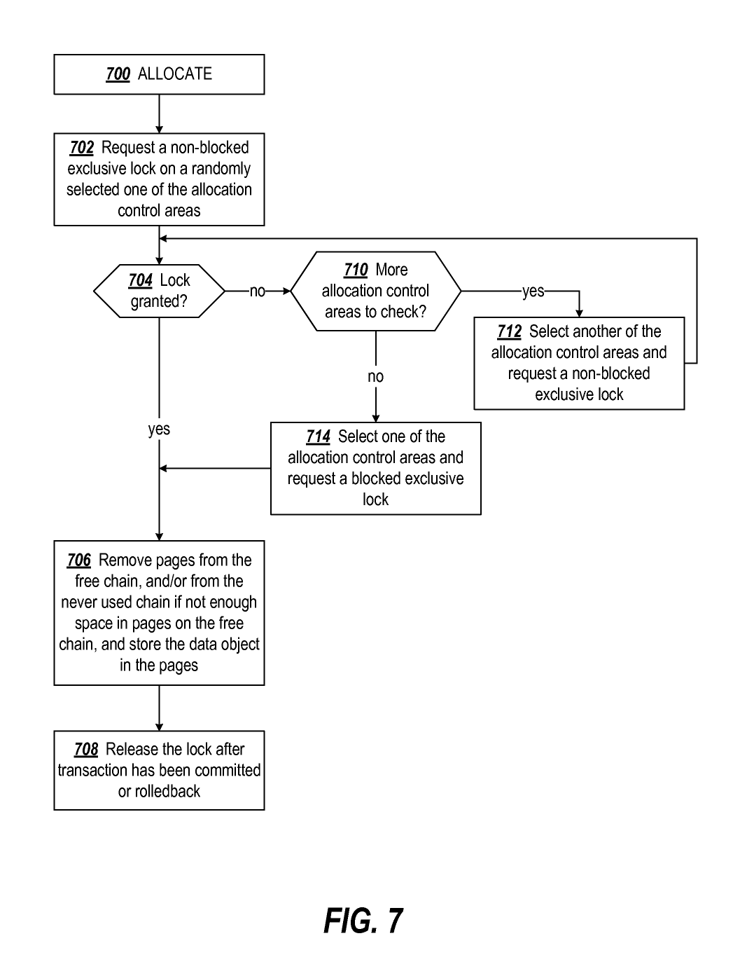

FIG. 7 is a flowchart of an example process for allocating free pages of a file to a data object, for purposes of inserting the object in a database, for example. The allocation is generally performed in response to a request to insert a data object in a database for example. In one embodiment, the process pseudo-randomly selects one of the allocation control areas for which to request a non-blocked exclusive lock at step 702. If the lock is granted, decision step 704 directs the process to step 706, where pages are removed from the free chain if there is sufficient storage, or from the never-used chain if the free chain does not have sufficient storage. The data object is stored in the allocated data pages. At step 708, the exclusive lock is released after the transaction has been committed or rolled back.

If at decision step 704 the lock was denied, the process proceeds to decision step 710 to determine whether or not there are more allocation control areas for which the process has not attempted to obtain a non-blocked exclusive lock. If there are more to check, at step 712 the process selects one of the non-checked allocation control areas, for example, the next one in sequential order, and requests a non-blocked exclusive lock. The process then returns to decision step 704 to determine whether or not the lock was granted as described above. If the process has made requests for non-blocking exclusive locks on all the allocation control areas and been denied a lock, decision step 710 directs the process to step 714 to select one of the allocation control areas and request a blocked exclusive lock. Once the lock is granted, control returns and the process continues at step 706 as described above.

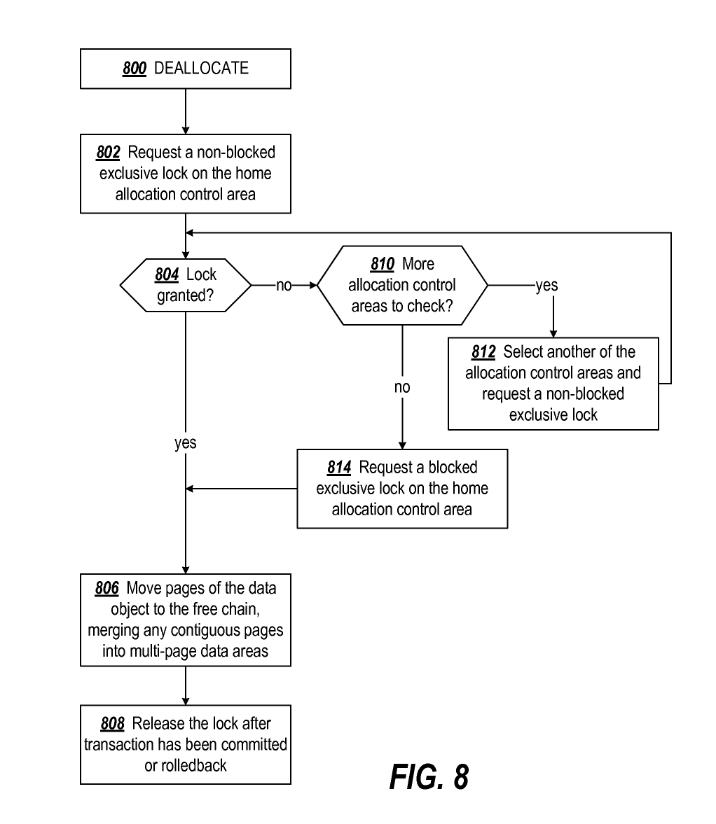

FIG. 8 is a flowchart of an example process for returning pages to an allocation control area after deleting an object from a database, for example. At step 802, the process requests a non-blocked exclusive lock on the home allocation control area of the pages to be returned. In one embodiment, the identifier of the home allocation control area is stored in the header of each of the pages to be returned.

If the lock was granted, decision step 804 directs the process to step 806, where the pages are linked in with the other pages on the free chain of the locked allocation control area. If any of the pages of the deleted data object are physically contiguous with any pages in the free chain, those pages are combined into one or more allocable data areas. In an embodiment which includes a header page for each object stored, each allocable data area includes two or more physically contiguous pages linked in the free chain. In another embodiment which does not include a header page for each object stored, each allocable data area includes one or more physically contiguous pages linked in the free chain.

If the lock was denied, decision step 810 tests whether or not there are additional allocation control areas for which non-blocked exclusive lock requests have not been attempted. If so, one of the unchecked allocation control areas is selected and an unblocked exclusive lock request is submitted at step 812. In one embodiment, the selection of the allocation control area is made pseudo-randomly. In another embodiment, the selection is in a predetermined order such as round-robin. Processing then returns to decision step 804 as described above.

If non-blocked exclusive lock requests were made for all the allocation control areas and all those lock requests were denied, at step 814 the process requests a blocked exclusive lock on the home allocation control area. Once the lock is granted, the process continues at step 806 to link the pages of the deleted object in with the free chain in the home allocation control area.

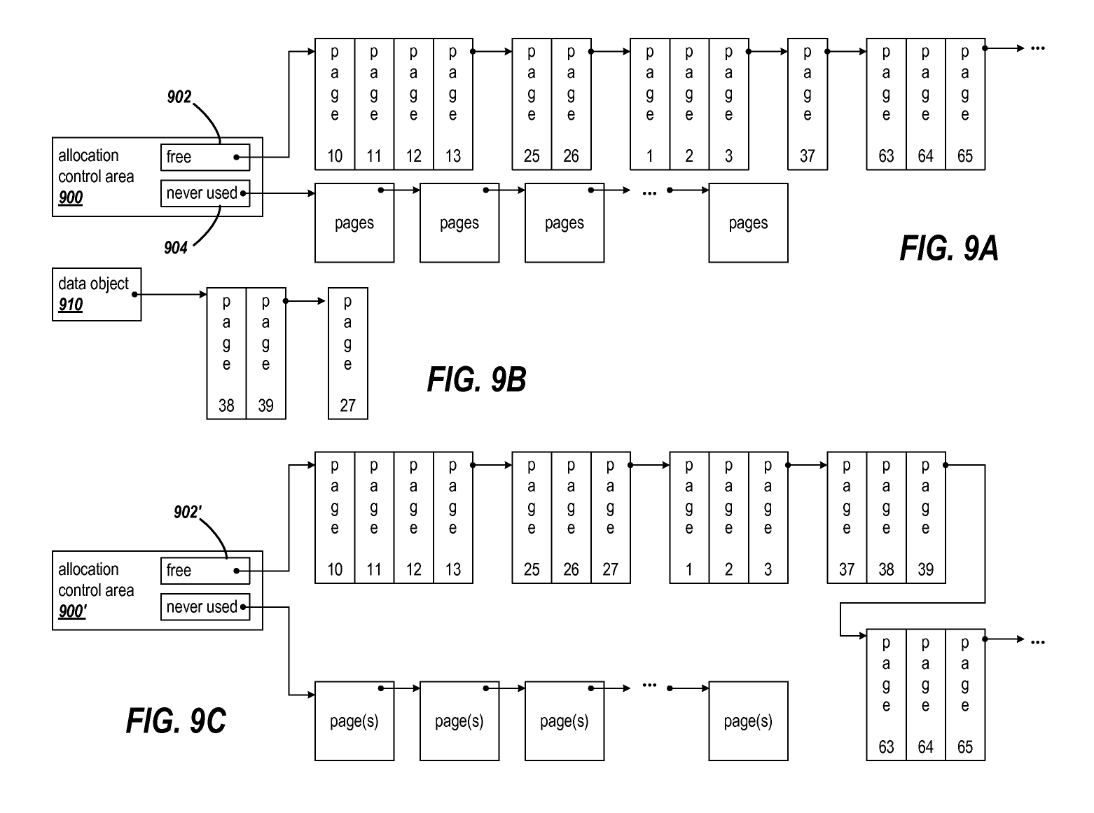

FIG. 9A shows an allocation control area and examples of the associated free pages before deleting a data object, FIG. 9B shows the pages of the data object to be deleted; and FIG. 9C shows the allocation control area and the associated free pages after the data object has been deleted. The allocation control area 900 includes pages on free chain 902 and pages on never-used chain 904. The pages on the free chain include an allocable data area with physically contiguous pages 10-13, an allocable data area with physically contiguous pages 25-27, an allocable data area with physically contiguous pages 1-3, an allocable data area with a single page 37, an allocable data area with physically contiguous pages 63-65 etc. In one embodiment, the pages on the free chain may be out of order since when pages are returned to the free chain they are placed at the beginning of the free chain. Another embodiment orders the pages on the free chain according to some scheme such as sorted ascending or descending by page number.

The data object 910, which is to be deleted and pages returned to the allocation control area 900, includes pages 38, 39, and 27. Allocation control area 900′ shows the free chain 902′ after the pages of the deleted object have been returned. Note that page 27 has been merged with pages 25 and 26 into one allocable data area on the free chain, and pages 38 and 39 have been merged with page 37 into another allocable data area on the free chain.

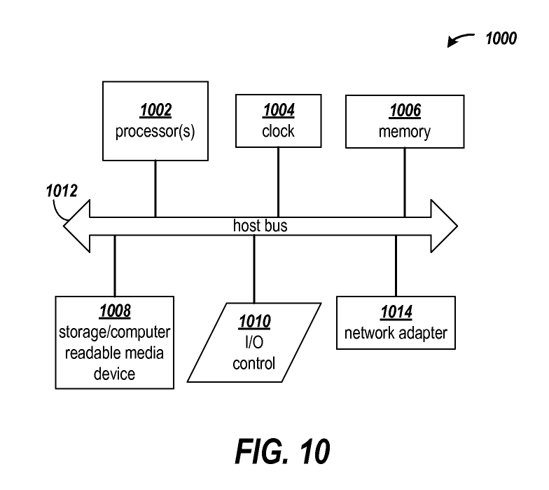

FIG. 10 is a block diagram of an example computing arrangement which can be configured to implement the processes described herein. Those skilled in the art will appreciate that various alternative computing arrangements, including one or more processors and a memory arrangement configured with program code, would be suitable for hosting the processes and data structures and implementing the algorithms of the different embodiments of the present invention. The computer code, comprising the processes of the present invention encoded in a processor executable format, may be stored and provided via a variety of computer-readable storage media or delivery channels such as magnetic or optical disks or tapes, electronic storage devices, or as application services over a network.

Computing arrangement 1000 includes one or more processors 1002, a clock signal generator 1004, a memory unit 1006, a storage unit 1008, a network adapter 1014, and an input/output control unit 1010 coupled to host bus 1012. The computing arrangement 1000 may be implemented with separate components on a circuit board or may be implemented internally within an integrated circuit. When implemented internally within an integrated circuit, the processor computing arrangement is otherwise known as system on a chip.

The architecture of the computing arrangement depends on implementation requirements as would be recognized by those skilled in the art. The processor 1002 may be one or more general purpose processors, or a combination of one or more general purpose processors and suitable co-processors, or one or more specialized processors (e.g., RISC, CISC, pipelined, etc.).

The memory arrangement 1006 typically includes multiple levels of cache memory, and a main memory. The storage arrangement 1008 may include local and/or remote persistent storage such as provided by magnetic disks (not shown), flash, EPROM, or other non-volatile data storage. The storage unit may be read or read/write capable. Further, the memory 1006 and storage 1008 may be combined in a single arrangement.

The processor arrangement 1002 executes the software in storage 1008 and/or memory 1006 arrangements, reads data from and stores data to the storage 1008 and/or memory 1006 arrangements, and communicates with external devices through the input/output control arrangement 1010 and network adapter 1014. These functions are synchronized by the clock signal generator 1004. The resources of the computing arrangement may be managed by either an operating system (not shown), or a hardware control unit (not shown).

The present invention is thought to be applicable to a variety of systems for managing allocation and de-allocation of storage to data objects. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for managing storage for data objects, comprising:
storing data describing a plurality of allocation control areas, each allocation control area referencing a respective set of free pages of a storage arrangement that are available for allocation for storing data objects;
in response to a request to delete a data object, requesting a non-blocking exclusive lock on an initial one of the allocation control areas;
in response to the non-blocking exclusive lock being granted, returning each page having data of the data object to the respective set of free pages of the initial one of the allocation control areas; and
in response to the non-blocking exclusive lock being denied on the initial one of the allocation control areas, determining another one of the allocation control areas to which a non-blocking exclusive lock can be granted, and returning each page having data of the data object to the respective set of free pages of the another one of the allocation control areas.

2. The method of claim 1, further comprising, in response to a non-blocking exclusive lock being denied on each of the allocation control areas, requesting a blocking exclusive lock on a selected one of the allocation control areas, and returning each page having data of the data object to the selected one of the allocation control areas in response to the exclusive lock being granted.

3. The method of claim 2, wherein the selected one of the allocation control areas is the initial one of the allocation control areas.

4. The method of claim 2, further comprising:
wherein before any pages have been allocated from the plurality of allocation control areas for storing data objects, the allocation control area that references each respective set of free pages is a home allocation control area of the respective set of free pages; and
wherein the initial one of the allocation control areas on which the non-blocking exclusive lock was requested is the home allocation control area of each page of the data object.

5. The method of claim 4, wherein the selected one of the allocation control areas is the initial one of the allocation control areas.

6. The method of claim 4, wherein the data object stores an identifier of the home allocation control area of each page in which the data object is stored.

7. The method of claim 1, further comprising:
wherein the respective sets of free pages are maintained as chains of allocable data areas under control of the allocation control areas, and each allocable data area includes a single page or two or more contiguous pages; and
wherein the returning of each page having data of the data object to one of the allocation control areas includes, for each page having data of the data object that is contiguous with a page in an allocable data area on the free list, adding the page to the allocable data area.

8. The method of claim 1, wherein the determining another one of the allocation control areas to which a non-blocking exclusive lock can be granted includes randomly selecting another one of the allocation control areas until an exclusive lock is granted.

9. The method of claim 1, wherein the determining another one of the allocation control areas to which a non-blocking exclusive lock can be granted includes selecting another one of the allocation control areas in a predetermined order until an exclusive lock is granted.

10. The method of claim 1, further comprising:
wherein the respective sets of free pages are maintained as chains of allocable data areas under control of the allocation control areas, and each allocable data area includes a single page or two or more contiguous pages; and
in each respective set of free pages, combining two or more contiguous pages into a single allocable data area on the free chain that is allocable for storing data of a data object.

11. A method for managing storage of data objects, comprising:
storing data describing a plurality of allocation control areas, each allocation control area having an associated respective set of free pages that are available for allocation for storing data objects, wherein before any pages have been allocated from the allocation control areas for storing data objects, the allocation control area under which each respective set of free pages is maintained is a home allocation control area of the respective set of free pages;
in response to a request to store a data object, requesting a non-blocking exclusive lock on a first one of the allocation control areas;
in response to the non-blocking exclusive lock being granted on the first one of the allocation control areas, removing one or more free pages from the respective set of free pages of the first one of the allocation control areas, storing data of the data object in the one or more pages, and storing in one of the one or more pages an identifier of the home allocation control area of the one or more pages;
in response to a request to delete the data object, requesting a non-blocking exclusive lock on a second one of the allocation control areas;
in response to the non-blocking exclusive lock being granted for the second one of the allocation control areas, returning each page having data of the data object to the second one of the allocation control areas; and
in response to the non-blocking exclusive lock being denied on the second one of the allocation control areas, determining a third one of the allocation control areas to which a non-blocking exclusive lock can be granted, and returning each page having data of the data object to the third one of the allocation control areas.

12. A system for managing storage for data objects, comprising:
a processor arrangement;
a memory coupled to the processor arrangement, the memory configured with instructions executable by the processor arrangement for controlling deallocation of memory from data objects;
wherein the processor arrangement in executing the instructions,
writes to the memory, data describing a plurality of allocation control areas, each allocation control area referencing a respective set of free pages of a storage arrangement that are available for allocation for storing data objects;
in response to a request to deallocate memory from a data object, requests a non-blocking exclusive lock on an initial one of the allocation control areas;
in response to the non-blocking exclusive lock being granted, adds each page having data of the data object to the respective set of free pages of the initial one of the allocation control areas; and
in response to the non-blocking exclusive lock being denied on the initial one of the allocation control areas, determines another one of the allocation control areas to which a non-blocking exclusive lock can be granted, and adds each page having data of the data object to the respective set of free pages of the another one of the allocation control areas.

13. The system of claim 12, further comprising, in response to a non-blocking exclusive lock being denied on each of the allocation control areas, requesting a blocking exclusive lock on a selected one of the allocation control areas, and returning each page having data of the data object to the selected one of the allocation control areas in response to the exclusive lock being granted.

14. The system of claim 13, wherein the selected one of the allocation control areas is the initial one of the allocation control areas.

15. The method of claim 13, further comprising:
wherein before any pages have been allocated from the plurality of allocation control areas for storing data objects, the allocation control area that references each respective set of free pages is a home allocation control area of the respective set of free pages; and
wherein the initial one of the allocation control areas on which the non-blocking exclusive lock was requested is the home allocation control area of each page of the data object.

16. The system of claim 15, wherein the selected one of the allocation control areas is the initial one of the allocation control areas.

17. The system of claim 15, wherein the data object stores an identifier of the home allocation control area of each page in which the data object is stored.

18. The system of claim 12, further comprising:
wherein the respective sets of free pages are maintained as chains of allocable data areas under control of the allocation control areas, and each allocable data area includes a single page or two or more contiguous pages; and
wherein the returning of each page having data of the data object to one of the allocation control areas includes, for each page having data of the data object that is contiguous with a page in an allocable data area on the free list, adding the page to the allocable data area.

19. The system of claim 12, wherein the determining another one of the allocation control areas to which a non-blocking exclusive lock can be granted includes randomly selecting another one of the allocation control areas until an exclusive lock is granted.

20. The system of claim 12, wherein the determining another one of the allocation control areas to which a non-blocking exclusive lock can be granted includes selecting another one of the allocation control areas in a predetermined order until an exclusive lock is granted.
